(19) United States
(12) Patent Application Publication
(10) Pub. No.: US 2010/0037050 A1
(43) Pub. Date: Feb. 11, 2010

(54) METHOD AND APPARATUS FOR AN ENCRYPTED MESSAGE EXCHANGE

(76) Inventor: CUNEYT KARUL, Toronto (CA)

Correspondence Address: BENNETT JONES LLP, 3400 ONE FIRST CANADIAN PLACE, PO BOX 130, TORONTO, ON, M5X 1A4, CA

(21) Appl. No.: 12/187,082

(22) Filed: Aug. 6, 2008

(51) Int. Cl. H04L 9/00

(52) U.S. Cl. 713/167

(57) ABSTRACT

An apparatus and method for exchanging encrypted messages or data. According to an embodiment, messages are encrypted according to credentials associated with a user and the encrypted messages are stored in memory. The credentials are encrypted and stored in a key services module. To retrieve a message, the user logs onto to a server with a password, and the server retrieves the encrypted credentials associated with the user from the key services and applies the user password to decrypt or recover the encrypted credentials. If the credentials are successfully recovered, the server uses the decrypted credentials to decrypt the message and the decrypted message is made available to the user.

### FIELD OF THE INVENTION

The present invention relates to secure delivery and receipt of encrypted data in a public key infrastructure (PKI), and more particularly to secure delivery and receipt of encrypted data utilizing a trusted server for user credentials.

### BACKGROUND OF THE INVENTION

Electronic mail or email has taken on unparalleled use and has become an invaluable tool that enables parties to communicate work products quickly, easily, and efficiently. While email is very convenient, the security of data communicated using email continues to be a concern. For example, as corporate correspondence moves from paper to digital form and hackers become more proficient at comprising email communications, the threat of unauthorized access to confidential corporate information increases.

Accordingly, there remains a need for improvements for securing email messaging, particularly in the case of sensitive business information.

### SUMMARY OF THE INVENTION

The present application is directed generally to embodiments of a method and an apparatus for encrypted message exchange.

According to one aspect, there is provided an apparatus for retrieving an encrypted message intended for a user, the apparatus comprises: a server configured for encrypting a plurality of encrypted messages and the plurality of messages are encrypted according to credentials associated with the user, and the user has a password; the server is configured to be responsive to a request from the user for retrieving one or more of the encrypted messages; the server is configured to request the credentials associated with the user, and the credentials are transferred to the server in an encrypted form; the server is configured to recover the credentials using the password of the user; and the server is configured to decrypt the encrypted message using the recovered credentials and make the decrypted message available for the user.

According to another aspect, there is provided a method for retrieving an encrypted message intended for a user and the message is stored in a memory device, the method comprises the steps of: retrieving the encrypted message from the memory device; requesting one or more credentials associated with the user and intended for decrypting the encrypted message; decrypting the requested credentials based on a password associated with the user; applying the decrypted credentials to decrypt the encrypted message; making the decrypted message available to the user.

According to another aspect, there is provided a method for exchanging an encrypted message to a recipient, the method comprises the steps of: composing a message for the recipient; encrypting the message according to credentials associated with the recipient; storing the encrypted message in a memory device; encrypting the credentials associated with the recipient with a user password; and sending an notification to the intended recipient that a message intended for the recipient is waiting.

According to another aspect, there is provided an apparatus for sending an encrypted message to a recipient, the apparatus comprises: a server configured for composing a message and encrypting the message according to credentials associated with the recipient; a memory for storing the encrypted message; the server is configured for encrypting the credentials associated with the intended recipient based on a user password for the recipient; and the server is configured to notify the recipient that an encrypted message intended for the recipient is waiting for retrieval from the memory.

Other aspects and features will become apparent to those ordinarily skilled in the art upon review of the following description of embodiments in conjunction with the accompanying figures.

### BRIEF DESCRIPTION OF THE DRAWINGS

Reference will now be made to the accompanying drawings which show, by way of example, embodiments of the apparatus and methods described herein, and how they may be carried into effect, and in which:

FIG. 1 shows in diagrammatic form a system for decrypting and reading an encrypted message according to an embodiment of the present invention;

FIG. 2 shows in diagrammatic form a system for encrypting and sending an encrypted message according to an embodiment of the present invention;

FIG. 3 shows a screen shot of a Logon screen for the system according to an embodiment of the present invention;

FIG. 4 shows a screen shot of a Sender's message log screen for the system according to an embodiment of the present invention; and

FIG. 5 shows a screen shot of a Notifications Options screen for the system according to an embodiment of the present invention;

Like reference numerals indicate like or corresponding elements in the drawings.

### DETAILED DESCRIPTION OF THE EMBODIMENTS

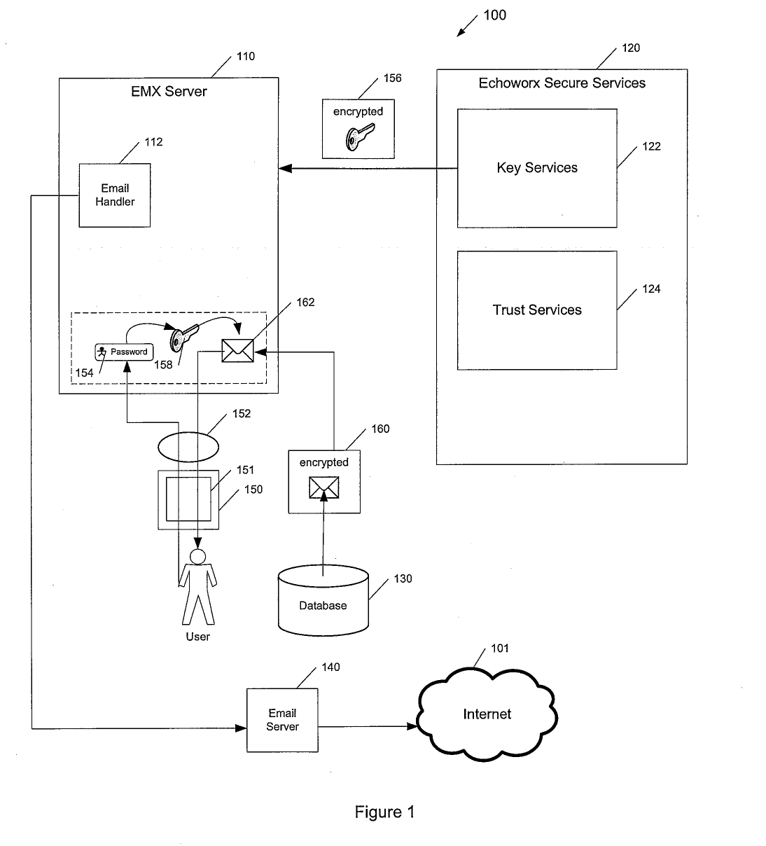

Reference is first made to FIG. 1, which shows in diagrammatic form an encrypted message exchange system according to an embodiment of the invention and configured for decrypting and reading an encrypted message. The encrypted message exchange system is indicated generally by reference 100 in FIG. 1.

As shown in FIG. 1, the encrypted message exchange system 100 comprises an encrypted message exchange (EMX) server 110, a secure services module 120, and a database 130. According to an embodiment, encrypted email messages and/or email messages with encrypted content, for example, S/MIME encryption, are stored in the database 130, for example, comprising a database management system (DBMS) or file server. The email messages are received from one or more senders via an email server 140 connected to a network, such as the Internet 101, a local area network (LAN), a wide area network (WAN), or other type of private or public network. According to another embodiment, the system 100 is configured to allow a web-based user to send a message to another user internally and the message never leaves the environment of the secure server 110. According to an embodiment, the EMX server 110 is configured with a module or application that receives messages (e.g. encrypted messages or email) and encrypts the email (or a decrypted secure message) according to the user's credentials and stores the encrypted message(s) 160 in the database 130 or a local memory or storage device. According to another aspect, the EMX server 110 is configured to keep a single copy of a message (e.g. email) that was sent to multiple recipients. This has the effect of reducing duplication and/or minimizing storage capacity needs.

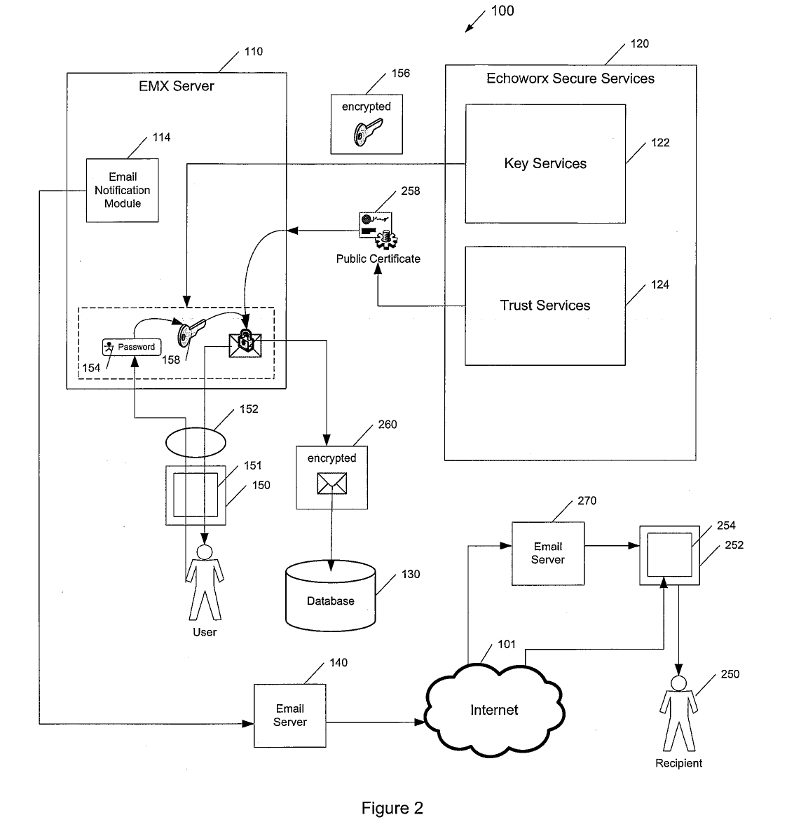

Referring still to FIG. 1, the EMX server 110 according to an embodiment comprises an application 151 that is configured for a Web and/or Application server. The EMX server 110 is accessible by both senders of messages and recipients of messages through a conventional web browser 150, for example, Internet Explorer from Microsoft Corporation, and Firefox from Mozilla. The secure services module 120 is configured to provide a number of services including PKI infrastructure management services, publishing public keys for users (i.e. customers), signing private credentials, recovering private credentials for users. According to an embodiment, the secure services module 120 is implemented with the Echoworx Secure Services (ESS) module available from Echoworx Corporation of Toronto, Ontario. As shown, the secure services module 120 includes a key services module 122. According to an embodiment, the key services module 122 is configured to provide user credential signing and recovery services. According to an aspect, the key services module 122 is configured to provide an encrypted copy of a user's private key in response to a request from the EMX server 110. According to another aspect, the encrypted copy of the private key cannot be decrypted without the original password of the user, for example, the password set by the user during product registration. According to another aspect, the services module 120 includes a trust services module 124. The trust services module 124 is configured, according to an embodiment, to provide public credentials, e.g. a public certificate (for example, indicated by reference 258 in FIG. 2), for recipients of secure messages. The server 110 utilizes the public credentials in the encryption and sending of a secure email or message as will be described in more detail below with reference to FIG. 2.

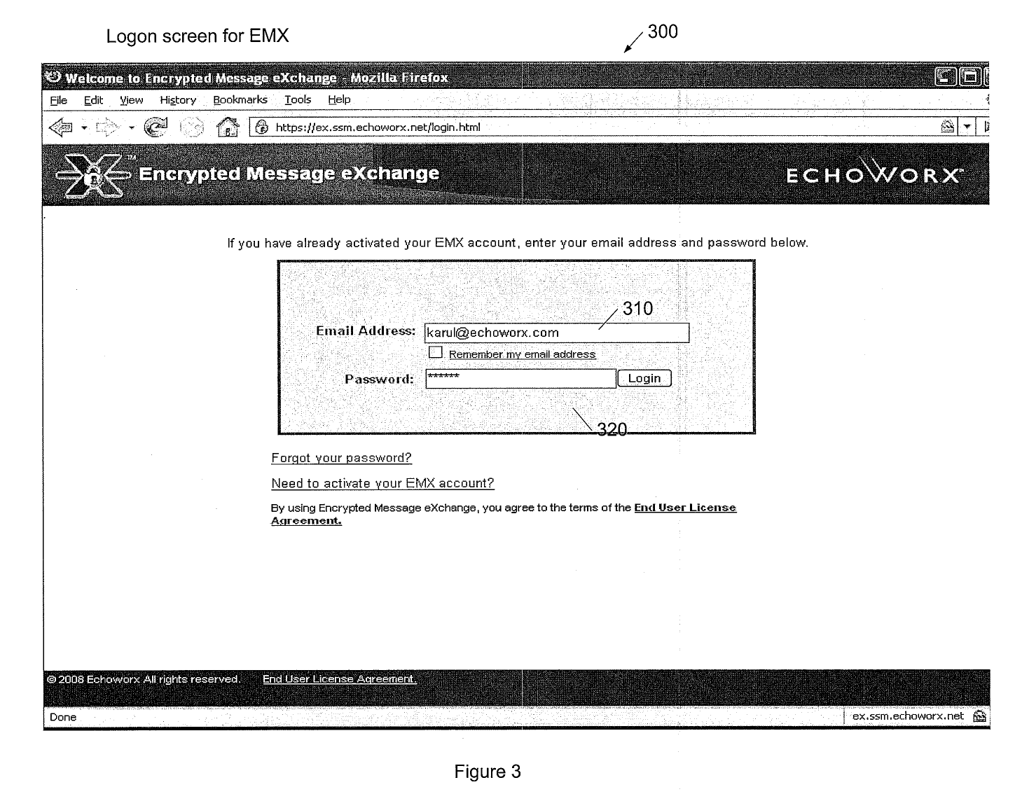

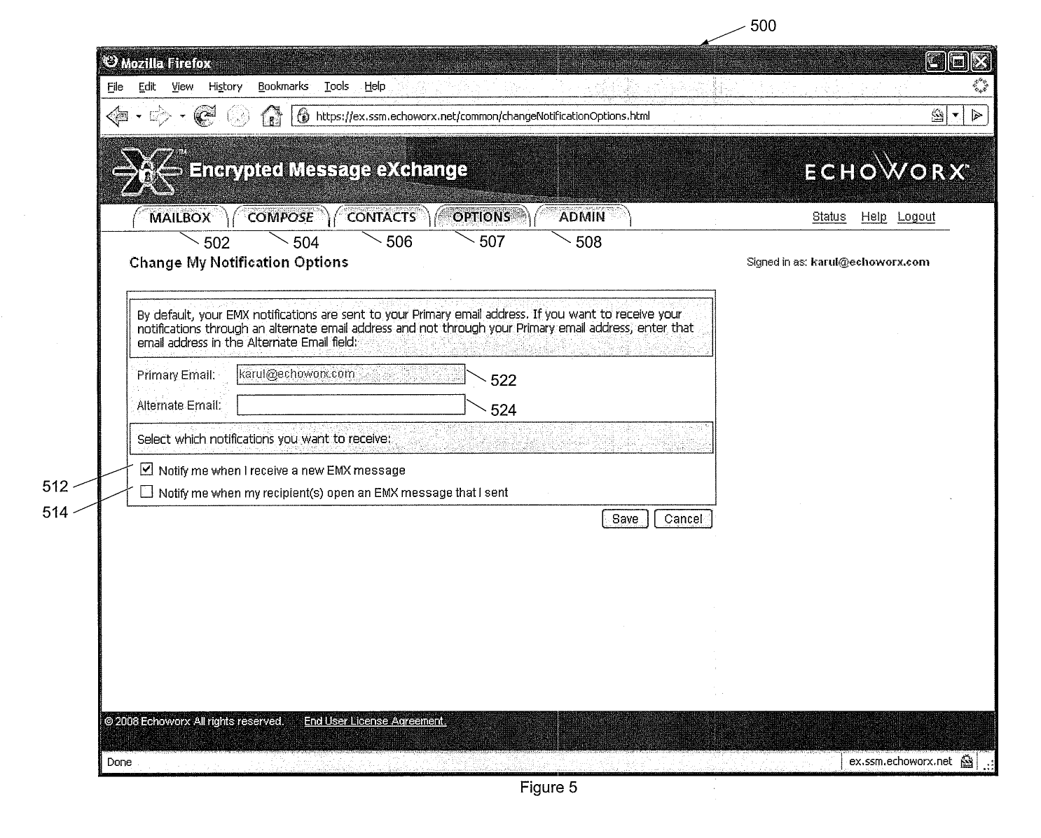

According to an embodiment, an encrypted message is decrypted and read through the EMX server 110 as follows:
the user receives a notification (for example, an email from the email server 140) of a new or unread message, e.g. an email with encrypted content
the user accesses the EMX server 120 through a Web page 151 on a web browser 150 on the user's computer; for example, the notification can include an HTML link to the Web page
according to an embodiment, a secure channel 152, such as SSL or TLS, is established with the EMX server 110 in order to maintain the confidentiality or integrity of communications between the user and the server 110
the user logs on the server 110 with a previously set user password 154 (i.e. set by the user during product registration), for example, using a log-on page as shown in FIG. 3, to access the message that was delivered to the server
in response to the log-on, the EMX server 110 is configured is generate a request to the key services module 122 in the secure services module 120 to retrieve the encrypted version of the user's credentials, e.g. an encrypted copy of the user's private key 156
the EMX server 110 attempts to decrypt the user's private key 156 received from the key services module 122 with the user's password 154; if private key 156 is successfully decrypted, i.e. a recovered key 158, then the decrypted credential (i.e. recovered private key) 158 is cached in memory for the application, for example, for the duration of the HTTP session, and the log-on process is completed; if, on the other hand, the private key 156 is not successfully decrypted, for example, the user supplied password 154 is invalid or incorrectly entered, then the log-on procedure is aborted; according to another aspect, the message(s) associated with a user and stored in the database 130 are encrypted with the user's (i.e. recipient's) private key and therefore a second layer of protection is provided should the authentication procedure during log-on be circumvented
the server 110 uses the recovered key 158 to decrypt encrypted messages 160 from the database 130 into corresponding decrypted messages 162
according to an embodiment, the server 110 is configured to retrieve and decrypt the encrypted messages 160 one at a time, i.e. in response to a user request to read a specific message
according to another aspect, the server 110 is configured to format the decrypted message 162 and present the formatted message to the user's browser 150 via the secure channel or communication path 152; an embodiment of a web-based browser page or application is shown in FIG. 5 and described in more detail below
   According to another aspect, the server 110 includes a message handler or application module 112 configured for handling email (e.g. encrypted S/MIME email) received from the email server 140 and storing the email in the database 130. According to an embodiment, the message handler 112 is configured to decrypt the encrypted email according to the user's credentials and then encrypt the email and store the encrypted email 160 in the database 130. According to another aspect, the message handler 112 is configured to store one copy of an email that is addressed to multiple recipients.

Reference is next made to FIG. 2, which shows the encrypted message exchange system 100 configured or operational for encrypting and sending an encrypted message or email to a recipient, indicated by reference 250 in FIG. 2. The user, i.e. sender, invokes the web browser 150 on their computer and loads a web page/application 151 and opens a session, i.e. an HTTP session, on the encrypted message exchange server 110. According to an embodiment, a message is encrypted and sent through the EMX server 110 as follows:
according to an embodiment, a secure channel 152, such as SSL or TLS, is established with the EMX server 110 in order to maintain the confidentiality or integrity of communications between the user and the server 110
the user logs on the server 110 with a previously set user password 154 (i.e. set by the user during product registration), for example, using a log-on page as shown in FIG. 3
in response to the log-on, the EMX server 110 is configured is generate a request to the key services module 122 in the secure services module 120 to retrieve the encrypted version of the user's credentials, e.g. an encrypted copy of the user's private key 156
the EMX server 110 attempts to decrypt the user's private key 156 received from the key services module 122 with the user's password 154; if private key 156 is successfully decrypted, i.e. a recovered key 158, then the decrypted credential (i.e. recovered private key) 158 is cached in memory for the application, for example, for the duration of the HTTP session, and the log-on process is completed; if, on the other hand, the private key 156 is not successfully decrypted, for example, the user supplied password 154 is invalid or incorrectly entered, then the log-on procedure is aborted; according to another aspect and as described above, the message(s) associated with a user and stored in the database 130 are encrypted with the user's (i.e. recipient's) private key and therefore a second layer of protection is provided should the authentication procedure during log-on be circumvented or compromised
once the user's private key 156 is recovered, i.e. converted into a decrypted key 158, it is used by the web browser application 151 to sign outgoing messages (e.g. email) on behalf of the user
according to another aspect, to encrypt or secure the message for the intended recipient's public certificate(s), the secure server 110 is configured to make a request to the trust services module 124 to retrieve a public certificate (indicated by reference 258 in FIG. 2) for the intended recipient 250
the secure server 110 is configured (e.g. with an application or function) to encrypt the message using the retrieved public certificate 258 to produce an encrypted message; according to an embodiment, the message is encrypted in S/MIME format and signed with the user's private key 158, and the resulting encrypted and signed message (indicated by reference 260 in FIG. 2) is stored in the database 130 and ready for delivery to the intended recipient
according to an embodiment, the intended recipient 250 receives a notification, for example, via a message generated by an email notification module 114 and the message is transmitted to an email server 270 and read by the recipient 250 at a computer 252; the message includes a URL (or HTML link) which allows the recipient to connect through a web browser 254 running on the computer 252 to the database via a secure channel or link over the Internet 101; once connected to the database, the recipient 250 retrieves the secure message 260, for example, as described above with reference to FIG. 1

Reference is next made to FIG. 3, which shows a screen shot of a log-on page according to an embodiment of the invention and indicated generally by reference 300. According to an embodiment, the log-on page 300 is accessed via a URL on a web browser, for example, Internet Explorer from Microsoft. According to an embodiment, a user logs onto the secure server 110 (FIG. 1) by entering a user name, e.g. “Email Address”, in a user name field 310 and a password in a password field 320. The password entered by the user corresponds to the password 154 described above. When the user logs onto the secure server 110, a channel is secured by SSL or TLS. As described above, the user's password 154 is used by the secure server 110 to decrypt private credentials and the decrypted credentials are stored in a secure memory segment for the duration of the HTTP session established by the log in procedure.

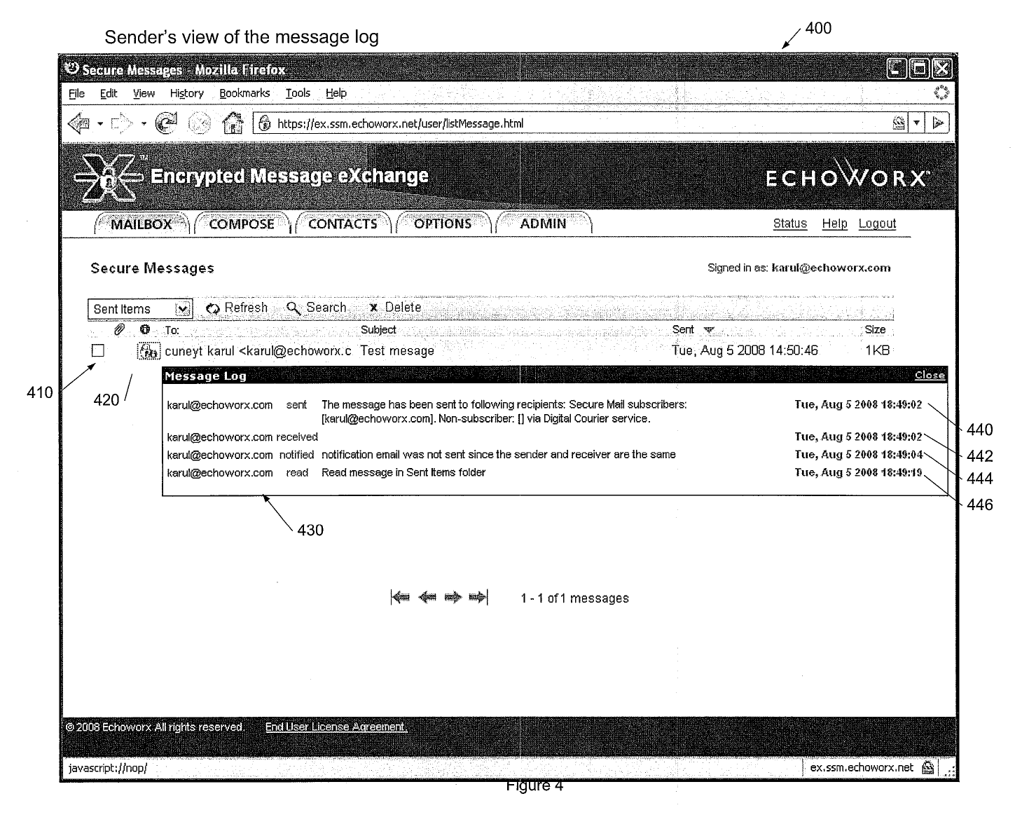

Reference is next made to FIG. 4, which shows a screen shot of a message log page or window for a sender, and indicated generally by reference 400. According to an embodiment, the secure server application is configured with a message log module to log or record every action associated with a secure message. As shown, the message log page 400 includes a window or panel 410 which lists “Sent” (“Received” or “All” email messages). Each of the emails includes an associated icon (e.g. an HTML element) indicated by reference 420. According to an embodiment, the message log module is configured to display a message log window as shown in FIG. 4 and indicated by reference 430. The message log window 430 provides a history (e.g. a real-time history) of the associated message. In this example, a “sent” email message has been selected by the user and the user can view:
when the message was delivered (for example, as depicted in line 440)
when the message was received (for example, as depicted in line 442)
when or if the recipient was notified (for example, as depicted in line 444)
when or if the recipient read the message (for example, as depicted in line 446)
   According to an aspect, the message log module (in the secure server 110) together with the message log page 400 provide an end-to-end audit log and/or proof of delivery mechanism for each message over its lifetime in the system 100. This allows a user, e.g. a sender, to verify that the message was delivered, received, and/or read by the intended recipient(s). According to another aspect, the graphic interface embodied in the message log page 400 facilitates user interaction.

Reference is next made to FIG. 5, which shows a screen shot of a web page or browser application 500 for the secure server application configured with a notification options window, indicated generally by reference 510. The notification options page 510 is accessed through an “Options” tab 507. According to an embodiment, the secure server application is configured to allow a user to choose or configure the type of notification they would like to receive when they receive a new message and/or when the message they have sent is opened by the intended recipient. According to an embodiment, the notifications are provided by emails which are sent to the intended recipient and/or the sender, for example, as described above. As shown in FIG. 5, the notification options page 510 includes a check box 512 for configuring a new message notification and a check box 514 for configuring a sent message open notification. According to another aspect, the notification options page 510 includes a primary email notification input field 522 and a second or alternative email notification input field 524. This allows a user to choose, for example, the email that he/she would like to be notified on for a waiting secure message.

As shown in FIG. 5, the secure server application page 500 also includes a “Mailbox” tab 502, a “Compose” tab 504, a “Contacts” tab 506, and an “Admin” tab 508. The Compose tab 504 allows a user to invoke a compose window that is configured for composing/editing secure messages that are intended for one or more recipients, and retrieved as described above.

According to an embodiment, the functions, logic processing, databases, and encryption/decryption processes performed in the operation of the system 100 as described above may be implemented in computer software comprising one or more computer programs, objects, functions, modules and/or software processes. It will be appreciated by one skilled in the art that the various functions, logic processing, databases, and/or the encryption/decryption processes/operations set forth may also be realized in suitable hardware, firmware/software, and/or firmware/software logic blocks, objects, modules or components or in combination thereof. The particular implementation details will be within the understanding of one skilled in the art.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. An apparatus for retrieving an encrypted message intended for a user, said apparatus comprising:
a server configured for encrypting a plurality of encrypted messages and said plurality of messages being encrypted according to credentials associated with the user, and the user having a password;
said server being configured to be responsive to a request from the user for retrieving one or more of said encrypted messages;
said server being configured to request the credentials associated with the user, and said credentials being transferred to said server in an encrypted form;
said server being configured to recover said credentials using the password of the user; and
said server being configured to decrypt said encrypted message using said recovered credentials and make the decrypted message available for the user.

2. A method for retrieving an encrypted message intended for a user and said message being stored in a memory device, said method comprising the steps of:
retrieving the encrypted message from the memory device;
requesting one or more credentials associated with the user and intended for decrypting the encrypted message;
decrypting said requested credentials based on a password associated with the user;
applying said decrypted credentials to decrypt the encrypted message;
making said decrypted message available to the user.

3. A method for exchanging an encrypted message to a recipient, said method comprising the steps of:
composing a message for the recipient;
encrypting the message according to credentials associated with the recipient;
storing the encrypted message in a memory device;
encrypting the credentials associated with the recipient with a user password; and
sending a notification to the intended recipient that a message intended for the recipient is waiting.

4. An apparatus for sending an encrypted message to a recipient, said apparatus comprising:
a server configured for composing a message and encrypting the message according to credentials associated with the recipient;
a memory for storing the encrypted message;
said server being configured for encrypting said credentials associated with the intended recipient based on a user password for the recipient; and
said server being configured to notify the recipient that an encrypted message intended for the recipient is waiting for retrieval from said memory.
